(19) United States
(12) Patent Application Publication
(10) Pub. No.: US 2010/0178398 A1
(43) Pub. Date: Jul. 15, 2010

(54) Marinating Apparatus and Process

(76) Inventors: Victor Kingsun Wai, Sui Lam NT (HK); John Cammanaro, Pompano Beach, FL (US)

Correspondence Address: Jellett Law, PS;Matthew Jellett, Esq., 910 Harris Ave, Suite A205, BELLINGHAM, WA, 98225, US

(21) Appl. No.: 12/354,769

(22) Filed: Jan. 15, 2009

(51) Int. Cl. A23L 1/31; A47J 43/00

(52) U.S. Cl. 426/281; 99/472

(57) ABSTRACT

A marination device for marinating a food item. The marination device includes a flavor injector configured to inject during a first stage marinating process liquid preparation into the food. A vacuum canister configured to pressurize to a negative pressure state during a second stage marinating process the food. The food is vacuumed to remove the air in the food, and re-pressurized to an atmospheric state in the vacuum canister to imbue the liquid preparation into the food.

### RELATED APPLICATIONS

This application claims priority benefit and fully incorporates herein by reference U.S. Ser. No. 29/330,305 filed Jan. 5, 2009.

### BACKGROUND

US-2006-0222741 is an apparatus and process for marinating where the foodstuff is marinated in a short period of time. In the summary of the invention section in paragraph [0004] “the apparatus includes a food holding container . . . and also contains a base comprising a plurality of cavities complementary to the extensions protruding downward away from the bottom wall. The extensions fit within the cavities so as to secure the food holding container to the base.” In paragraph [0005] “The base contains a shaft for transmitting ultrasonic mechanical vibrations from a source of ultrasonic vibrations is activated, vibrations are directly transmitted to food holding container . . . when marinade is placed in the food holding container, ultrasonic vibrations will enhance the absorption . . . ” Further in paragraph [0007], “the vibrating marinator is combined with an injection marinator for marinating foodstuff . . . sidewalls are configured so as to contain a deep cavity having an inner edge and an outer edge that is continuous around the circumference of the food holding container.”
US 2008/0035772 discloses a flavor infuser which is a handheld food processor having a weighted cylindrical universal handle with a circular triangular shaped base which can accommodate various detachable optional pieces. The base pieces contemplated include a piercing tenderizer assembly, course plate, and a smooth plate.
US 2008/0085347 discloses a vacuum marination device which requires users to first depress a primary plunger to evacuate essentially all of the air from a chamber in which food items in a marinade are sealably contained. As can be seen in the summary the invention section paragraph 1 0 “a container has a variable volume into which food items and a marinade liquid can be placed. The container has a concave bottom to ensure that the marinade is distributed to as much of the surface area of food as possible and resist deformation due to pressure experienced when the pressure in the container is lowered.”
US 2008/0095902 is a marinating device which has a base, a food marinating container which provides sideward movement of the marinating connect container at a first sideward direction and an electric driving arrangement. Referring to the summary of the invention section in paragraph [0011] “the present invention is to provide a marinating device comprising a food marinating container which has a container sidewall and comprises a guiding rib for retaining the position of the marinating container when it is rotating on a supporting base.”
U.S. Pat. No. D572,074 discloses a design for a vacuum marinator. The design appears to have a cylindrical case with the vacuum plunger at the lid location.
U.S. Pat. No. 5,934,187 discloses a marinade applicator which has a substantially cylindrical container for various liquid seasonings or marinades. Referring to column 2 around line 27 “The container has a cylindrical top opening for accommodating a screw-on top having a plurality of needles or prongs attached. Prongs have hollow cavities with channels for delivering marinade to a meat product. A plurality of conically shaped tips are essentially attached to the prongs by a recessed plainer base which forms a cavity in the cone.”
U.S. Pat. No. 5,057,332 discloses an apparatus and process for marinating foodstuff, where the apparatus includes a base assembly and a removable cover which define an airtight vessel for holding the foodstuff and marinade and a vacuum pump assembly for withdrawing air from the vessel through vacuum port communicating therewith. Referring to column 1 around line 51 in the summary of the invention section “the apparatus includes a pressure tight vessel and a pump assembly for withdrawing air from the vessel and maintaining the interior of the vessel at a reduced pressure . . . the pressure within the vessel is then reduced by withdrawing the air from the vessel, causing the foodstuff to swell, while the air trapped within the food is drawn therefrom. Foodstuff is then allowed to remain in the marinade for a short period of time, whereupon the interior vessel is returned to atmospheric pressure. As the pressure rises within the vessel, marinade passes into the foodstuffs, filling the voids created by the existing air, thereby rapidly tenderizing and imparting the flavor of the marinade to foodstuff.”
U.S. Pat. No. 3,441,980 discloses an injector meat tenderizing and flavoring preparations and substances which provides an injector for tenderizing and flavoring preparations and substances which produces, as can be seen in column 2 around line 14, “twisting and loosening the meat's muscle fibers, membranes and tendons, carrying force-injected, surface supplied, tenderizing and flavoring preparations and substances to the meat interior; and creating spaces to retain and hold interior meat juice in place and draw in surface moisture and air which fill the vacuum spaces and other voids and the lose and expanded texture of the meat thereby giving support to the expanded bulk.”
Eastman Outdoors Reveo MariVac Food Marinator. is a barbecue meat marinator which allows the user to rotate the meat in a cylindrical casing and it also appears to have an upper vacuum pump on the top lid of the casing.
The Instant Marinator. Is a dish that has a vacuum sealed top. By creating the vacuum, it opens the pores and fibers of the meat allowing for a very fast or instant marinade. The process also tenderizes the food.
The Food Saver Quick Marinator. is a 2¼ quart canister which vacuum seals and marinades meat

### BRIEF DESCRIPTION OF THE DRAWINGS

FIG. 1 is a perspective view of the device;

FIG. 2 is an exploded elevational view of the canister lid;

FIG. 3 is an exploded elevational view of the canister with injector;

FIG. 4 is a perspective bottom view of the injector bracket;

FIG. 5 is a perspective top view of the injector bracket;

FIG. 6 is a top plan view of the injector;

FIG. 7 is an elevational view of the injector;

FIG. 8 is a bottom plan view of the injector;

FIG. 9 is a flowchart of a marinating food process;

FIG. 10 is a sub flowchart of the first stage marinating process;

FIG. 11 is a sub flowchart of the second stage marinating process.

### DESCRIPTION OF THE PREFERRED EMBODIMENTS

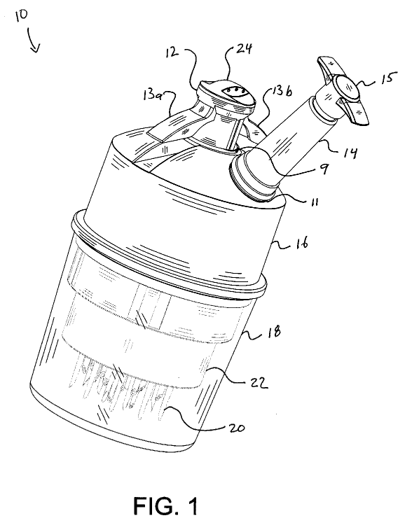

Referring to FIG. 1, a discussion of a first embodiment of a liquid preparation or marination device 10 will be provided. Generally speaking, the marination device is configured to hold a food item in the canister 18. The canister 18 is then covered with a canister lid 16. A sealing gasket is provided between the lid and canister for later vacuum sealing of the device. Within the canister lid 16 is arranged a flavor injector or injector assembly. The flavor injector has injector pins 20 a flavor injection handle 1 2, and an interior injection mechanism which is guided by an injector guide plate 22. The marination device also has a vacuum pump 14 which when operated can exert either a negative pressure or a positive pressure on the interior portion of the marination device.

The marination of the food item is done in a two-stage process and discussion of this process with reference to the figures will be provided. Before discussing the process, detailed discussions of each of the components of the marination device 10 will be provided. It should be kept in mind that the cylindrical configuration of the marination device 10 is one embodiment, while additional embodiments can be provided and are hereby envisioned. Additional embodiments include rectilinear or cubic configurations, noncircular elliptical cylinders, or variations between the two. Furthermore, while the present embodiment is designed for one or two food items within the canister 18, a configuration which holds more than approximately 2 food items is readily envisioned. Additionally, while a single injector is utilized, it is readily envisioned that multiple injectors may be utilized within the same marination device.

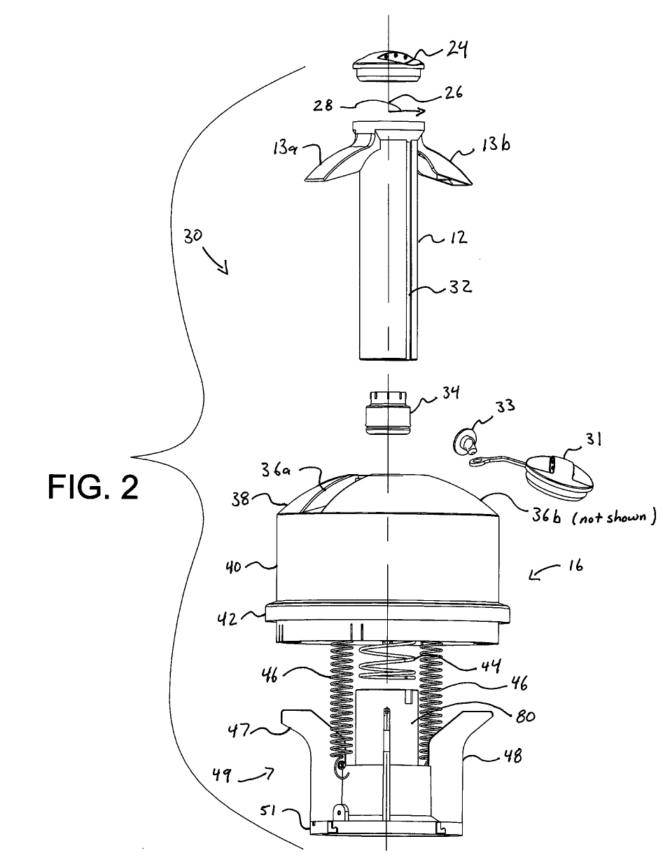

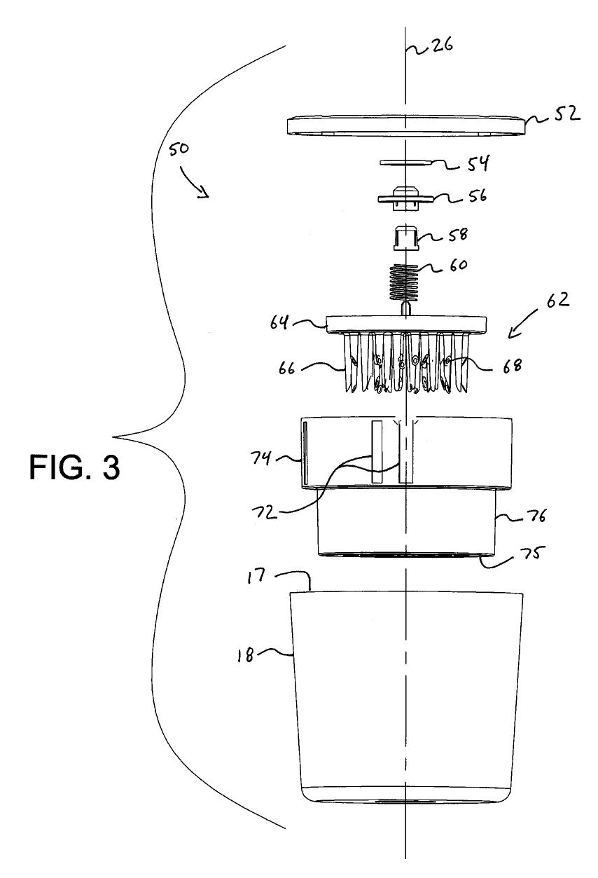

Reference will be made to FIGS. 2 and 3. In this present embodiment, the marination device 10 is arranged along a centrally aligned vertical axis 26 with a radial axis 28 radiating about the centrally aligned vertical axis. An exploded view of the canister lid with injector bracket 30 as seen in FIG. 2 is provided. Reference will first be made to the component parts of the flavor injector handle 12 in this particular embodiment which is arranged as a cylindrical shaft. The flavor injector handle 12 is a hollow and has a vertical notch 32 for slideable vertical alignment and to also resist rotation about the vertical axis 26. At the top portion of the flavor injector handle 12 is a marinade cap 24.

In this particular embodiment, the marinator cap 24 is a rubber cap, but in alternative embodiments, the cap can be made of ABS plastic, stainless steel metal and the like.

Furthermore, the entire marinator device 10 as seen in FIGS. 1, 2, and 3, can be constructed of various materials which are readily available within the art. For example, the materials may include ABS plastic, rubber, stainless steel, graphite, carbon fiber, or other materials utilized for creating similar consumer products.

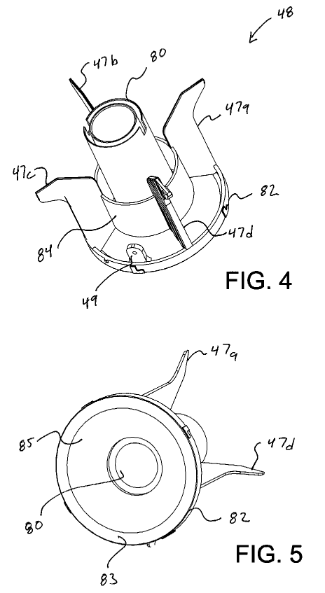

The flavor injector handle 12 has a flavor injector grip 13 which is an armiture radiating from the top portion of the cylindrical shaft. The flavor injector grips 13A and 13B may be seated within a flavor injector grip recess 36A and 36B. Seated within the bottom portion of the cylindrical shaft is a handle sleeve 34 for seating and maintaining the cylindrical shaft in its proper vertical alignment within the lid 16 of the marinating device 10. The canister lid 16 is the housing for maintaining the injector mechanism 49 which provides for alignment and pressurization of the injection process. The canister lid, has a semispherical lid top portion 38 a cylindrical lid main body portion 40 and a lid collar 42. Within the main housing, an injection spring 44 for providing uniform disbursement of the pressure being applied from the flavor injector handle on to the injection bracket 48 is provided. The injection spring 44 is seated within a handle guide chute 80 (FIG. 4).

When the injector is not being utilized, the injection bracket 48 and the entire injector mechanism 49 is maintained in its disengaged position or state where it is held stationary within the main body portion of the canister lid 16 by two return springs 46. These return springs are connected to the inner portion of the canister lid 16 as well as two spring brackets 49 attached to the bracket bottom wall end 82 (FIG. 4). Four male bracket guide arms 47 are circumferentially equidistantly arranged about the handle guide chute 84 guiding and limiting the upward and downward or the vertical movement of the injector mechanism 49 during the injection process.

Referring to FIG. 3, further discussion of the canister with the injector 50 as shown in an exploded view will be provided. The injector 62 is operably connected to the injector mechanism 49. To provide for vacuum sealing of air and liquids exiting the injection mechanism, an injector gasket 52 is provided to be seated between the lid collar 42 and the canister top edge 17. An injector plate assembly 53 which has an O-ring 54, an upper injector plate 56, a lower injector plate 58, and a lower injection spring 60 is seated on the injector top plate 64. This injector plate assembly 53 provides for additional attenuation of the injection downward force during the injection process.

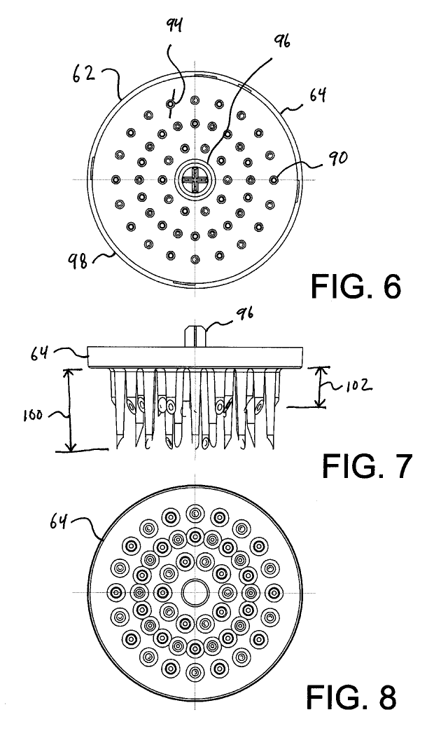

A detailed discussion of the injector 62 as seen in FIG. 3, and FIG. 6 through 8, will now be provided. As seen in FIG. 3, the injector top plate 64 is married to a plurality of injection pins 66. The injector 62 is configured to seat within the guide plate 70 and the injector pins 66 are arranged so that they protrude through the bottom wall 75 of the guide plate 70. The guide plate 70 has an inner diameter cylindrically aligned shell 76 and an outer diameter cylindrically aligned upper shell 74. Arranged vertically about the outer diameter upper shell 74 are four female bracket guide sleeves 72. These female bracket guide sleeves 72 are arranged to receive the male bracket guide arms 47 as previously discussed in FIG. 2.

Referring to FIG. 6, the injector top plate 64 has a marinade reservoir which is defined by an outer wall 98. Through the injector top plate 64 are arranged a plurality of marinade injection pin top ports 90. These pin top ports 90 are configured to allow the marinade held within the marinade reservoir to drain through the pin top ports 90 down into the injection pins 66. A rotational stay 96 is placed at the center point of the injector top plate 64. The injector ports with circular arrangement 92 are just one configuration of the injector pin ports. Linear or nonsymmetrical arrangements may also be provided.

In this particular embodiment there are two groups of injection pins, a first longer grouping of injection pins defined by first injection pin length 100, and a second shorter grouping of injection pins defined by a second injection pin length 102. While the present embodiment has two general lengths, it is conceived that the alternative embodiments may have arbitrary lengths, they may be the same length, or there may be more than two groupings of lengths of injector pins.

A more detailed discussion of the injector bracket 48 will now be provided as seen FIGS. 4 and FIGS. 5. As previously discussed, the injector bracket 48 has a bracket bottom wall 82 and in this particular embodiment it has four male bracket guide arms 47 which are connected to a bracket cylinder stay wall 84 and the bracket bottom wall 82. The male bracket guide arms 47A through 47D are spaced circumferentially equidistant at quarter points about the handle guide chute 80 and the bracket cylinder stay wall 84. Referring to FIG. 5, the bracket bottom wall 82 has an outer ring 83 and a slightly inner conically concave shaped wall 85. An opening in the concave inner wall portion allows for the handle 12 to extend into the handle chute 80.

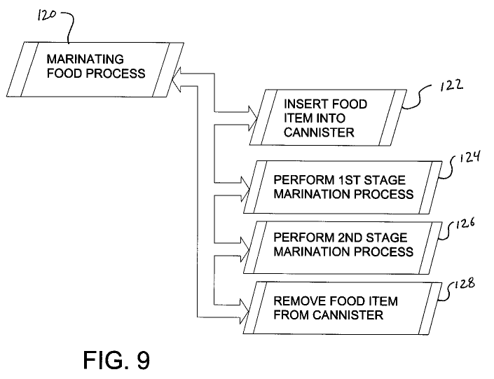

A detailed discussion of the use of the marinating device and a marinating food process 120 as seen in FIG. 9 will now be discussed. Generally speaking, the marination of the food item can be accomplished in a two-stage marination process. The first step in the marinating food process 120 is to insert the food item into the canister at step 122. Generally speaking the present embodiment is designed for approximately 2 food items, such as two steaks, but designs for holding more than two food items are readily envisioned. For example, a larger base canister with multiple injectors, a larger base canister with a larger single injector covering more surface area, or the ability for the injector to move laterally and transversely as desired by the user. The lateral and transverse movement may be accomplished by the use of a ball and socket hinge, the use of a lateral and transverse rail system, or the use of a flexible gasket in conjunction with the injector.

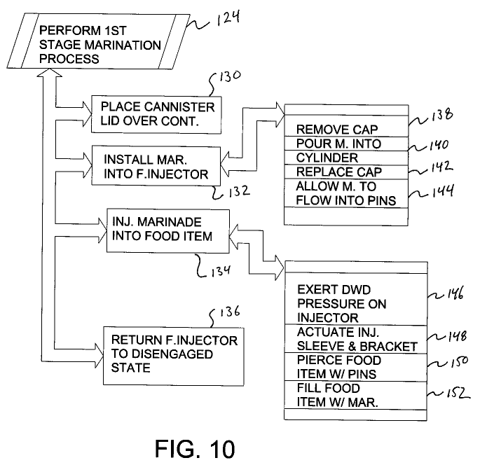

At step 124, the user can perform the first stage of the marination process. Generally speaking, as will be discussed further in FIG. 10, the user will be able to install marinade into the injector, and then forcibly inject a marinade using the injector into the food items. After the food item has been injected with marinade, the user can perform a second stage marination process at step 126 which involves extracting air from the inside of the marinator, the marinator including the canister lid and the canister, allowing the food items to expand in the vacuum space, and in doing so, the marinade seeping into the food items voided air pockets. The user then re-pressurizes the marinade device which seals the marinade into the food item.

At step 128, the user can remove the food item from the canister. Referring to FIG. 10, a detailed discussion of the first stage marination process will be provided. Prior to placing the canister lid over the canister at step 130, the user may have to engage the guide plate 70 is seen in FIG. 3, with the canister lid 16 which includes threading the injection pins 66 through the bottom wall 75 of the guide plate 70. The bottom wall 75 of the guide plate has a plurality of ports which line up with the injection pins 66 to allow for smooth mating of the guide plate to the canister lid 16.

With the guide plate secured to the canister lid, the user can place the canister lid over the canister at step 130. With the canister lid placed over the canister, the marinating device is ready for the first stage marination process. The user can at step 132, install the marinade into the flavor injector. This includes removing the cap at step 138 off of the top of the flavor injector handle. The user can then pour the marinade into the cylinder at step 140. The user then replaces the cap at step 142 on top of the flavor injector handle cylinder and the marinade is allowed to flow into the injection pins 66 (FIG. 3) as seen in step 144.

Once the marinade has been installed into the flavor injector, the user can begin the injection of the marinade into food item at step 134. This requires the user to exert a downward pressure on the injector at step 146 by applying pressure to, in this particular embodiment, the flavor injector handle 12 utilizing the flavor injector grips 13A and 13B as seen in FIG. 2. In doing so, the user actuates the injection sleeve and bracket for uniform downward pressure at step 148. When the proper pressure is reached, the injection pins 66 pierce the item at step 150. The flavor or marinade flows through the marinade ports 68 of the injection pins 66 and into the pierced food item. In doing so, the marinade fills into the food item at step 152 imbuing the food item with the marinade.

After two, three or four or more injections of the marinade into the food item as desired or until the marinade is fully absorbed into the food item, the user can then at step 136 return the flavor injector to its disengaged state. In this particular embodiment, the flavor injector will return to its disengaged state automatically due to the return spring action provided by the return spring 46 as seen in FIG. 2.

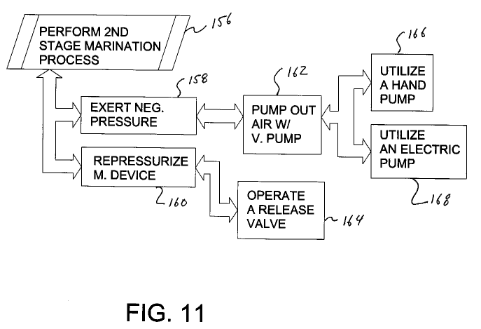

With the marinade fully injected into the food items, the user can now begin to perform a second stage marination process at step 156 as seen in FIG. 11. Here the user will attach the vacuum pump 15 as seen in FIG. 1 to the vacuum port 11. Optionally, if the user wishes to, he can remove the flavor injection handle 12 and place the marinade cap 24 over the flavor injector chute 9 to seal the canister lid 16. Or, the user can seal the canister lid by pressing the flavor injector handle 12 downwards seating it into the flavor injector grip recess 36 A and 36 B, and also locking the flavor injector handle into place for the second stage process. As previously discussed, the user will attach the vacuum pump 14 to the vacuum port 11 to exert a negative air pressure on the marinating device at step 158. This includes pumping out air with a vacuum pump at step 162, where the vacuum pump can be a handheld pump or an electric pump, either at step 166 or step 168.

The user in one embodiment, may pump for at least 10 intervals using the hand pump and when moderate resistance in the pump and canister lid is reached, the proper level of vacuumization will have been achieved. In order to re-pressurize the marinating device at step 116, the user can operate a release valve at step 164. The negative pressure will be released, the air in the marinade device will return the pressure to normal atmospheric pressure and the food will be fully marinated. The user can now remove the food item from the canister.

Therefore I claim:

1. A device for preparing a food item, said device comprising:
a. an injector assembly configured to inject a liquid preparation into said food item contained within said device during a first stage process;
b. a vacuum assembly configured during a second stage process to remove air from said device containing said food item; and
c. said vacuum assembly further configured to re-pressurize said device to an atmospheric state, further imbuing said liquid preparation into said food item;
d. a food canister configured to maintain said food item in said device during said first and second stage processes.

2. The device according to claim 1 wherein said food canister is further configured to create a vacuum seal with said injector assembly during said first and second stage processes.

3. The device according to claim 1 wherein said device further comprises: a gasket seal configured to create an airtight seal between said food canister and said injector assembly.

4. The device according to claim 1 wherein said injector assembly further comprises: an injector handle configured to receive said liquid preparation into said handle and transmit said liquid preparation into a plurality of injection pins.

5. The device according to claim 4 wherein said injector handle further comprises: a cylindrical shaft arrangement for slideable operation within said device.

6. The device according to claim 5 wherein said injector handle further comprises: a handle arrangement for a user to exert a downward force upon said shaft for injection of said liquid preparation into said food item.

7. The device according to claim 5 wherein said injector assembly further comprises an injection bracket and injection sleeve for transmitting a uniform downward pressure on said food item during said first stage process.

8. The device according to claim 5 wherein said injector assembly further comprises: a return spring component for returning said injector assembly back to a disengaged injection state.

9. The device according to claim 5 wherein said injector assembly further comprises: an injector top-plate configured to receive said liquid preparation from said injector handle and distribute said liquid preparation into a first group of injection pins.

10. The device according to claim 9 wherein said injector assembly further comprises: an injector reservoir maintained within said injector top plate and defined by an outer wall, said injector top plate further comprising a first group of injection ports configured to transmit said liquid preparation from said reservoir into said first group of injection pins.

11. The device according to claim 10 wherein said injector assembly further comprises: a second group of injection pins configured to interoperate with a second group of injection ports arranged within said injector top plate.

12. The device according to claim 1 wherein said injector assembly further comprises: a first group of injection pins comprising a first length, a second group of injection pins comprising a second length not the same as said first length.

13. A process for preparing a food item comprising:
a. inserting a food item into a canister;
b. performing a first stage preparation process by:
i. placing a canister lid over said canister to form a device, said canister lid comprising a housing, an injector assembly, a vacuum pump;
ii. installing a liquid preparation into said injector assembly;
iii. injecting said liquid preparation into said food item utilizing said injector assembly;
c. performing a second stage preparation process by:
i. exerting a negative air pressure in said device utilizing said vacuum pump;
ii. re-pressurizing said device to atmospheric pressure;
d. removing said food item from said canister by removing said canister lid and extracting said food item.

14. The process according to claim 13 wherein said first stage preparation process further comprises:
a. installing said liquid preparation into said injector assembly by:
i. removing a rubber cap located on said injector assembly;
ii. said injector assembly comprising a cylindrical shaft arrangement with a hollow core configured to receive said liquid preparation, said cylindrical shaft arranged for slideable operation within said device;
b. pouring said liquid preparation into said cylindrical shaft;
c. replacing said rubber cap onto said cylindrical shaft.

15. The process according to claim 14 wherein said first stage preparation process further comprises: allowing said installed liquid preparation to flow into an injector, said injector comprising a liquid preparation reservoir and a plurality of injection pins.

16. The process according to claim 15 wherein said first stage preparation process further comprises:
a. exerting a downward pressure by a user on said cylindrical shaft;
b. actuating a bracket within an injection sleeve for exertion of uniform downward pressure on said food item.

17. The process according to claim 16 wherein said first stage preparation process further comprises: piercing said food item with said plurality of injection pins; allowing said food item to fill with said liquid preparation flowing through said injection pins.

18. The process according to claim 17 wherein said first stage preparation process further comprises: injecting said food item with said liquid preparation until said liquid preparation saturates to an acceptable level within said food item.

19. The process according to claim 16 wherein said first stage preparation process further comprises: returning said injector assembly automatically back to a disengaged injection state by utilizing a return spring.

20. The process according to claim 13 above wherein said second stage preparation process further comprises: exerting a negative pressure in said device by: pumping out said air within said device utilizing said vacuum pump.

21. The process according to claim 20 above wherein said second stage preparation process further comprises: utilizing a hand pump.

22. The process according to claim 20 above wherein said second stage preparation process further comprises: utilizing an electric pump.

23. The process according claim 20 wherein said second stage preparation process further comprises: re-pressurizing said device to atmospheric pressure by operating a release valve on said device.

24. A means for preparing a food item comprising:
a. means for inserting a food item into a canister;
b. means for performing a first stage preparation process;
c. means for performing a second stage preparation process;
d. means for removing said food item from said canister.
